(19) United States
(12) Patent Application Publication
(10) Pub. No.: US 2024/0168312 A1
(43) Pub. Date: May 23, 2024

(54) ELECTRONIC CONTACT LENS PAIR SYMMETRY

(71) Applicant: Tectus Corporation, Saratoga, CA (US)

(72) Inventor: Donald Arthur Ice, Milpitas, CA (US)

(21) Appl. No.: 18/057,146

(22) Filed: Nov. 18, 2022

(51) Int. Cl. G02C 7/04; G02C 11/00

(52) U.S. Cl. CPC G02C 7/04; G02C 11/10

(57) ABSTRACT

A pair of electronic contact lenses comprises a left electronic contact lens and a right electronic contact lens, to be worn on the left and right eyes of a user, respectively. Each electronic contact lens contains a respective electronic payload comprising a set of electronic components. Each of the electronic payloads contains an equivalent layout of electronic components, but are oriented a different rotation angles relative to a reference axis of the respective contact lens, where the reference axis refers to an axis of the contact lens that points in a predetermined direction when the contact lens is worn by the user and the user's head is in an upright position.

### BACKGROUND

### 1. Technical Field

This disclosure relates generally to eye-mounted devices and in particular to electronic contacts lenses containing electronic payloads.

### 2. Description of Related Art

Contact lenses can include electronic components that provide various capabilities beyond the traditional capabilities of the contact lens. For example, contact lenses can include one or more projectors, such as femtoprojectors, to enable augmented reality (AR) functionality. In AR applications, images projected by the electronic contact lenses augment what the user would normally see as his external environment, for example, as overlays on the external environment.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1A shows a user wearing a pair of electronic contact lenses, in accordance with some embodiments.

FIG. 1B shows a cross sectional view of an electronic contact lens mounted on the user's eye, in accordance with some embodiments.

FIG. 1C shows a magnified view of one of the electronic contact lenses 105, in accordance with some embodiments.

FIG. 2A is a functional block diagram of an eye-mounted display using a scleral contact lens, in accordance with some embodiments.

FIG. 2B is a posterior view of an electronics assembly for use in an electronic contact lens, in accordance with some embodiments.

FIG. 3 illustrates an overhead view of the lens components of a pair of contact lens, in accordance with some embodiments.

FIG. 4A illustrates a diagram showing a pair of electronic contact lens worn by a user, in accordance with some embodiments.

FIG. 4B illustrates a closer view of the orientations of the left and right contact lenses 300-L and 300-R shown in FIG. 4A when worn by the user, in accordance with some embodiments.

FIG. 4C illustrates a diagram of the left and right contact lenses, where the payloads of the left and right contact lenses are mirror images, in accordance with some embodiments.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Contact lenses can include electronic components that perform various functions. For example, a contact lens may contain a sensor device for monitoring glucose concentration in tear fluid or for measuring intraocular pressure. As another example, a contact lens can include one or more femtoprojectors, such as that described by Deering in U.S. Pat. No. 8,786,675, “Systems using eye mounted displays,” incorporated herein by reference. A femtoprojector is able to project images onto the wearer's retina, thus superimposing virtual objects onto the field of view of the wearer and enabling the wearer to view an augmented reality.

Contact lenses, including contact lenses containing electronic components (hereinafter referred to as “electronic contact lenses”), are typically worn as a pair, one in each eye of the user. In some embodiments, each lens of a pair of electronic contact lenses contains a respective set of electronic components (also referred to as an “electronic payload” or “payload”). For example, a pair of electronic contact lenses used for AR applications may contain a femtoprojector in each lens (e.g., a left femtoprojector in a left lens, and a right femtoprojector in a right lens) each configured to, when the lenses are worn, each project images towards a respective eye of the user. In some embodiments, the femtoprojector is positioned near a center of the respective contact lens, to allow the femtoprojector to project light into the user's pupil to reach their retina, and is connected to one or more additional electronic components located in a peripheral area of the lens, such as a processor, a transmitter/receiver, one or more sensors, a battery or power coil, and/or the like. These components may be laid out in a specific arrangement or layout within the lens, based on a desired spatial relationship between the components, weight distribution within the contact lens, amount of light obscuration caused by the components within the lens, etc.

In some embodiments, an electronic contact lens, when worn by a user, is configured to fit in a specific orientation on the user's eye, so that the electronic components within the lens will be positioned at specific locations relative to the user's eye. For example, in an electronic contact lens containing a femtoprojector, the femtoprojector may be configured to be located at a specific location relative to the user's eye when the electronic contact lens is worn by the user, in order to be able to project light through the user's pupil to reach the user's retina. If the lens is rotated, translated, or otherwise made to deviate in position on the user's eye, images projected by the femtoprojector will appear at the wrong place in the user's vision, or be unable to project light onto the user's retina at all. In addition, some electronic contact lenses may include sensors (such as an eye tracking/orientation sensor), where information generated using the sensor is determined at least in part upon the location of the sensor relative to the user's eye. In some embodiments, the electronic payload of the electronic contact lens is mounted on or encapsulated within a lens component (discussed in greater detail below) that stably rests on the user's eye when the lens is worn, so that the lens is maintained in the desired position and orientation during wear.

While the human face is approximately symmetric about a vertical plane passing through the nose, it is impractical to design the electronic payload layouts of the left and right lenses of a pair electronic contact lenses to be mirror images of each other in the way left- and right-hand gloves are typically mirror images of each other. This is because most integrated circuits are only available in one handedness. For example, for a given type of integrated circuit chip, the pin-out configuration of the chip will have a specific configuration. There are not different left- and right-handed versions of the same chip, or a chip available with different left- and right-handed pin-out configurations. Consequently, if the electronic payloads of the left and right lenses of a pair of electronic contact lens were to include the same types of chips having the same handedness, the connection routing between the chips would need to be redesigned in order to maintain the same relative positions of the chips within the layout. The need to have different routing schemes for left and right lenses introduces additional complexity in designing and manufacturing electronic contact lenses, requiring the design and manufacture of two different electronic payload layouts, each specific to left-eye lenses or right-eye lenses.

In some embodiments, the left and right electronic payloads of a pair of electronic contact lens are designed to have share the same layout of electronic components, but have different orientations within their respective lenses, being rotated relative to each other by a specified amount lenses (e.g., by 180 degrees) with respect to a vertical axis of their respective contact. This simplifies design and manufacture, by allowing for a single electronic payload layout, or a single electronic payload layout with limited variations, to be used for both left and right lenses of a pair of electronic contact lenses.

As used herein, the center axis of a contact lens refers to an axis passing through a center of the contact lens that is substantially orthogonal to an outer surface of the contact lens. In some embodiments, the central axis of the lens is also referred to as the gaze axis of the lens, as it is configured to align with a gaze axis of the user's eye when the contact lens is worn by the user. The vertical axis of the electronic contact lens refers to an axis orthogonal to a center axis of the contact lens, that passes through the center of the contact lens and extends in a vertical direction when the contact lens is worn by the user, and the user's head and body are in an upright position. For example, in some embodiments, the vertical axis of the contact lens is parallel to the user's craniocaudal or longitudinal axis when the user's head and body are in an upright position. The vertical plane corresponds to a plane defined by the center axis and the vertical axis of the contact lens. As used herein, the horizontal axis of the electronic lens refers to an axis orthogonal to a center axis of the contact lens, that passes through the center of the contact lens and extends in a horizontal direction when the contact lens is worn by the user, and the user's head and body are in an upright position. The horizontal plane corresponds to a plane where corresponds to a plane defined by the center axis and the horizontal axis of the contact lens. Because the electronic contact lens is designed to fit on the user's eye with a specific position and orientation when worn, the vertical and horizontal axes of a given contact lens correspond to fixed axes on the contact lens, regardless of the actual orientation of the contact lens at a given time.

More generically, as used herein, a “reference axis” refers to an axis that is orthogonal to the center axis of the contact lens, and extends in a specified direction when the contact lens is in a particular orientation (e.g., the orientation of the lens when worn by the user, and the user's head and body are in an upright position). For example, where a left electronic contact lens is configured to be worn on a left eye of a user in a first orientation and a right electronic contact lens is configured to be worn on a right eye of the user in a second orientation, a given reference axis on the left contact lens corresponds to an axis oriented in a first direction when the left contact lens is in the first orientation, while the same reference axis on the right contact lens corresponds to an axis oriented in the first direction when the right contact lens is in the second orientation. The vertical and horizontal axes of the contact lens are types of reference axes.

In some embodiments, the layout of the electronic payload of the left and right electronic contact lens are equivalent, in that each of the left and right electronic payloads contains a same arrangement of electronic components, but where at least a subset of the electronic components may be different in each layout. In some embodiments, each of the left and right electronic payloads includes a plurality of common electronic components in corresponding locations of the left and right electronic component layouts. In addition, one or more electronic components in corresponding locations of the left and right electronic payload layouts may be of different types, but have equivalent footprints, e.g., having equivalent weight, dimensions, and/or pin-out configurations, reducing the need to design a wholly new layout for each payload. For example, in some embodiments, the left electronic payload may contain an electronic component corresponding to a first type of sensor at a particular location within the payload, while the right electronic payload includes an electronic component corresponding to a second type of sensor having an equivalent footprint located at a corresponding location within the payload.

In some embodiments, the electronic payload of each of the pair of electronic contact lenses comprises a printed circuit board or substrate on which the electronic components of the electronic payload may be mounted. The printed circuit board includes a plurality of mounting locations on which electronic components may be attached, and a plurality of traces between the mounting locations allowing for electronic components attached at the mounting locations to be connected. In some embodiments, the electronic payload further comprises additional interconnects connecting electronic components of the payload.

In some embodiments, the printed circuit boards of each of the left and right electronic contact lenses have the same shape with the same layout of mounting locations and traces, but the combination of electronic components mounted on the printed circuit board are different for each payload. For example, in some embodiments, the electronic components of each of the left and right electronic contact lens may have a common first set of electronic components (e.g., a controller, a femtoprojector, transmitter/receiver circuitry, power circuitry, etc.) mounted on corresponding locations of the respective printed circuit boards, and a second set of different electronic components (e.g., sensor circuitry and/or auxiliary components), which may be attached at different mounting locations on each of the printed circuit boards. In some embodiments, the left and right electronic payloads of a pair of electronic contact lens are configured such that the printed circuit boards and corresponding common first set of electronic components of the payloads are the same, but have different orientations within their respective lenses, being rotated relative to each other by a specified amount lenses (e.g., by 180 degrees) with respect to a vertical axis of their respective contact. On the other hand, the second set of different electronic components may be located at different locations on the respective printed circuit boards for each of the left and right electronic payloads.

In some embodiments, the layout of the electronic payload of the left and right electronic contact lens are designed to be functionally symmetric about the horizontal plane of the contact lens, or about a predetermined reference axis selected based upon an angle rotation between the left and right electronic payloads of the left and right contact lenses. As used herein, “functionally symmetric” means that gross features such as weight and aggregate component sizes are approximately symmetric, but details such as component types, signal routes, chip placement, internal chip layout, and chip pinout assignments may not be. As such, even though the layout of the electronic payload of the right contact lens is oriented differently from that of the left contact lens when the lenses are worn by a user, the weight distribution and light obscuration of the right electronic payload will mirror that of the left electronic payload across the vertical axis of the lenses. Thus, each electronic payload of each lens is functionally symmetric about the horizontal plane of the lens, and the payloads of the pair of lenses are functionally symmetric with each other with respect to a vertical plane of the lenses.

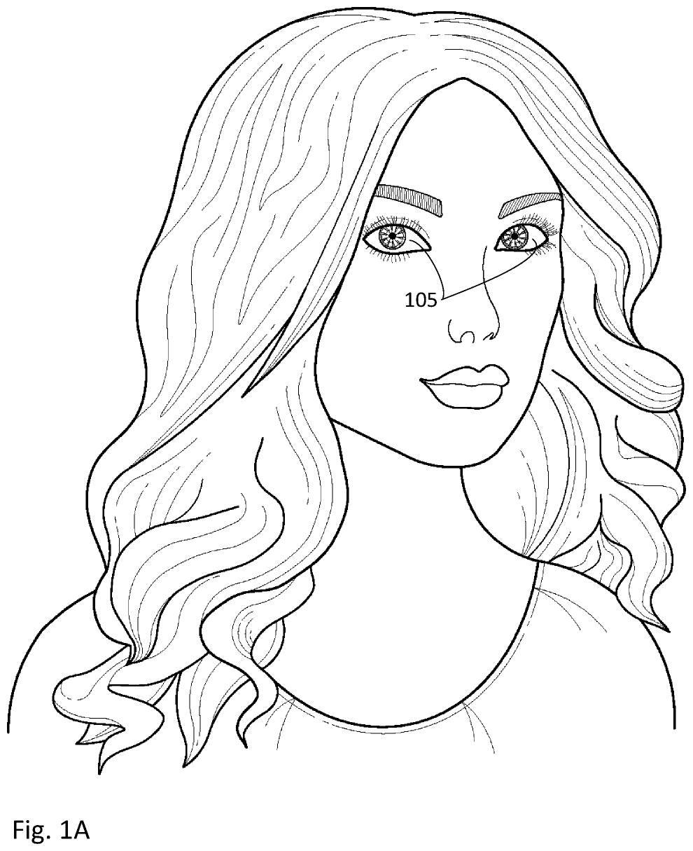

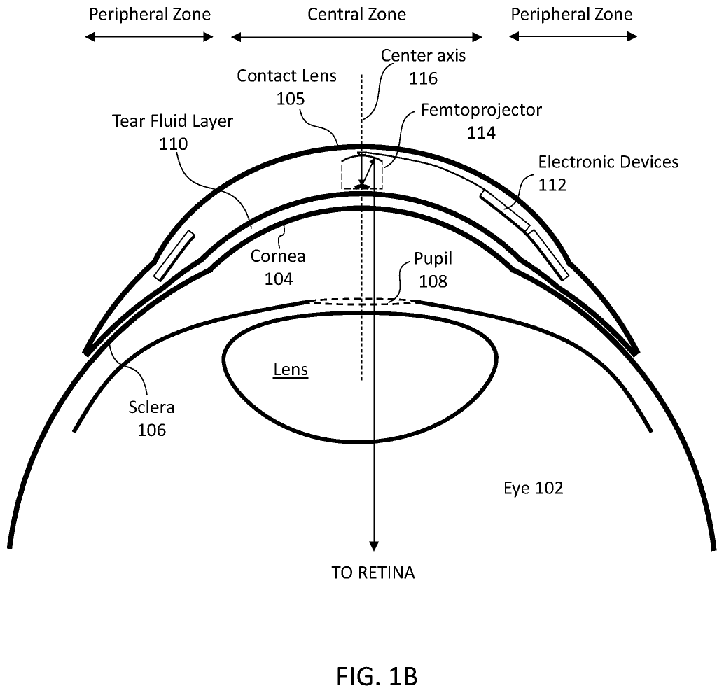

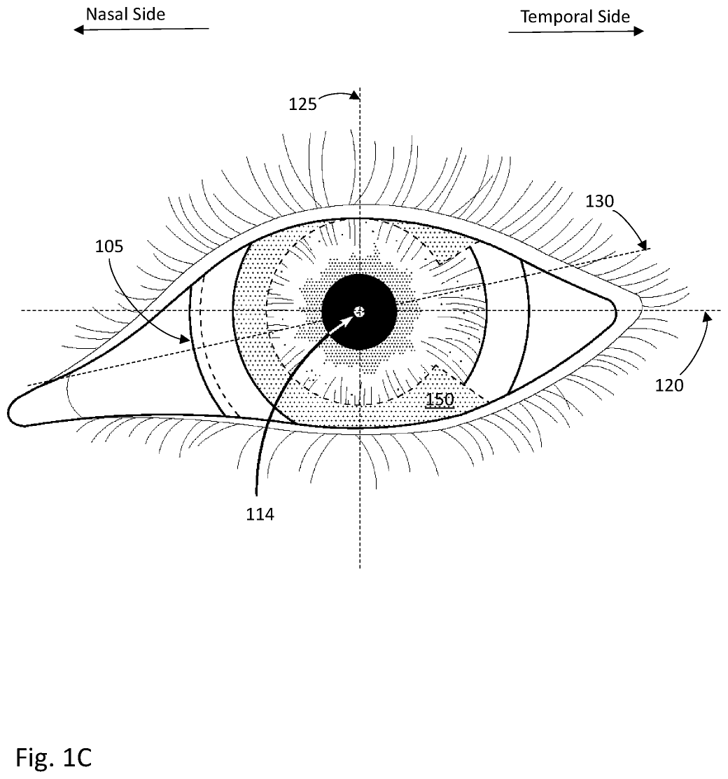

FIG. 1A shows a user wearing a pair of electronic contact lenses, in accordance with some embodiments. As shown in FIG. 1A, the pair of electronic contact lenses 105 comprises includes a left contact lens and a right contact lens, worn in the left and right eyes of the user, respectively. In some embodiments, each of the electronic contact lens 105 contains a respective femtoprojector configured to project images into the respective eye of the user. In some embodiments, each of electronic contact lenses 105 of the pair of electronic contact lens contains different electronic components, e.g., different types of sensors. For example, in some embodiments, the pair of electronic contact lens 105 contains a respective femtoprojector and a different combination of sensors on each lens.

FIG. 1B shows a cross sectional view of an electronic contact lens mounted on the user's eye, in accordance with some embodiments. The electronic contact lens 105 shown in FIG. 1B may correspond to one of the electronic contact lens 105 shown in FIG. 1A. In some embodiments, the electronic contact lens 105 is implemented as a scleral contact lens. Scleral contact lenses are designed to be mounted on the sclera of the user's eye such that they do not move around on the wearer's eye, and are positioned in a fixed orientation when worn. The following examples use a scleral contact lens in which the contact lens is supported by the sclera of the user's eye, but it is understood that in other embodiments, other types of contact lenses where the contact lens has a fixed position and orientation on the user's eye when worn may also be used.

The user's eye 102 includes a cornea 104, a sclera 106, and a pupil 108. The scleral contact lens 105 is supported by the sclera 106 and vaults over the cornea 104, typically forming a tear fluid layer 110 between the contact lens 105 and the cornea 104. In some embodiments, the contact lens 105 may contain materials or features (not shown) facilitating the permeation of oxygen through the contact lens 105 to provide oxygenation to the user's cornea 104 through the tear fluid layer 110.

The electronic contact lens 105 contains an electronic payload comprising one or more electronic components. In the example of FIG. 1B, the payloads include a small projector that projects images onto the wearer's retina (e.g., femtoprojector 114), and the additional electronics 112 to operate the femtoprojector, to perform image processing functions associated with the femtoprojector, and/or to perform other types of functions within the electronic contact lens 105. For example, the additional electronics 112 may include microprocessors/controllers/image processing circuitry, one or more sensors (e.g., motion sensors such as accelerometers, gyroscopes and magnetometers), transmitter/receiver circuitry, power circuitry, antennas, batteries and elements for receiving electrical power inductively for battery charging (e.g., coils), etc. The femtoprojector 114 may include an LED frontplane with an LED array, an ASIC backplane with electronics that receives the data to drive the LED frontplane, and optics to project light from the LED array onto the retina. The femtoprojector 114 preferably fits into a 2 mm by 2 mm by 2 mm volume or even into a 1 mm by 1 mm by 1 mm volume. In some embodiments, the femtoprojector 114 and additional electronics 112 are powered by a coil (not shown) around the periphery of the contact lens, a battery located within the contact lens 105 (not shown), or both.

The femtoprojector 114 is positioned over the cornea 104 when the electronic contact lens 105 is worn, to allow the femtoprojector 114 to project images through the user's pupil 108 onto the user's retina. On the other hand, the electronics 112 may be positioned away from the cornea, as shown in FIG. 1B. For convenience, the contact lens 105 is divided into a central zone and a peripheral zone. The central zone may refer to an area of the contact lens that overlaps the cornea 104 of the eye 102, where light traveling through the central zone may pass through the user's pupil 108 to reach the user's retina. On the other hand, the area of the contact lens outside the cornea is referred to as the peripheral zone, where light passing through the peripheral zone does not pass through the user's pupil 108 to reach the user's retina. As illustrated in FIG. 1B, the femtoprojector 114 is located within the central zone of the contact lens, while the additional electronics 112 are located in the peripheral zone. As people have eyes of different sizes and shapes. The diameter of the boundary between the cornea and the sclera is typically between 10 and 12.5 mm, so for convenience, the central zone may be defined as the 10 mm diameter center area of the contact lens (i.e., within 5 mm radius of the center axis 116 of the contact lens). Payload components that project light onto the retina, such as the femtoprojector 114, typically will be located within the central zone due to the required optical path. Conversely, payload components that do not project light onto the retina or otherwise interact with the retina may be located on the edge of the central zone or outside the central zone so that they do not block light from reaching the retina.

In some embodiments, the electronic payload of the contact lens includes powered devices such as sensors, imagers, and eye tracking components such as accelerometers, gyroscopes and magnetometers. In some embodiments, the electronic payload may also include passive devices, such as a coil or antenna for wireless power or data transmission, capacitors for energy storage, and passive optical structures (e.g., absorbing light baffles, beam-splitters, imaging optics). The contact lens 105 may also contain multiple femtoprojectors, each of which projects images onto the user's retina. Because the contact lens 105 moves with the user's eye 102 as the user's eye rotates in its socket, the femtoprojectors mounted in the contact lens 105 will also move with the user's eye and project to the same region of the retina. For example, some femtoprojector(s) may always project images to the fovea, and other femtoprojector(s) may always project images to more peripheral regions which have lower resolutions. As a result, different femtoprojectors may have different resolutions. The images from different femtoprojectors may be overlapping, to form a composite image on the wearer's retina.

FIG. 1C shows a magnified frontal view of one of the electronic contact lenses 105, in accordance with some embodiments. The electronic contact lens 105 is worn on the surface of the user's eye. The lead line from reference numeral 105 in FIG. 1C points to the edge of the contact lens. The electronic contact lens 105 contains a femtoprojector 114 located in a central region of the contact lens, so that light from the femtoprojector 114 propagates through the user's pupil to the retina, as well as additional payload components (e.g., additional electronic components 112) located within a zone 150 of the contact lens. For clarity, connections between the femtoprojector and additional electronics are not shown in FIG. 1C. In some embodiments, the electronic contact lens may include cosmetic elements, for example covering the electronics in zone 150. The cosmetic elements may be surfaces colored to resemble the iris and/or sclera of the user's eye.

In some embodiments, the zone 150 is located within or substantially within the peripheral zone of the contact lens. In some embodiments, a distance at which the zone 150 extends towards a center of the contact lens varies over different portions of the contact lens, e.g., based on an angle relative to a reference axis of the contact lens (such as the horizontal axis 120 or the vertical axis 125). For example, as shown in FIG. 1C, the zone 150 may be cut out on the temporal side of the contact lens (referring to a side of the contact lens positioned closer to the user's temple when the contact lens is worn by the user, as opposed to the nasal side of the contact lens), e.g., between angles +θ and −θ from the horizontal axis 120 of the contact lens on the temporal side of the contact lens. In some embodiments, by limiting the area of the contact lens covered by the zone 150 on the temporal side of the contact lens, potential impact to the user's peripheral vision may be reduced. In contrast, the zone 150 may extend further inwards towards the center of the contact lens on the nasal side of the contact lens without impeding the user's peripheral vision, due to the user's peripheral vision on the nasal side already being inhibited by the user's nose.

In some embodiments, such as that shown in FIG. 1C, the shape of the zone 150 covered by the additional payload components of the contact lens is configured to be substantially symmetrical about the horizontal axis 120. In other embodiments, the shape of the zone 150 may be configured to be symmetrical about a different axis of the contact lens, such as a reference axis 130 of the contact lens selected based upon an inclination angle of the palpebral fissure of the user's left or right eye.

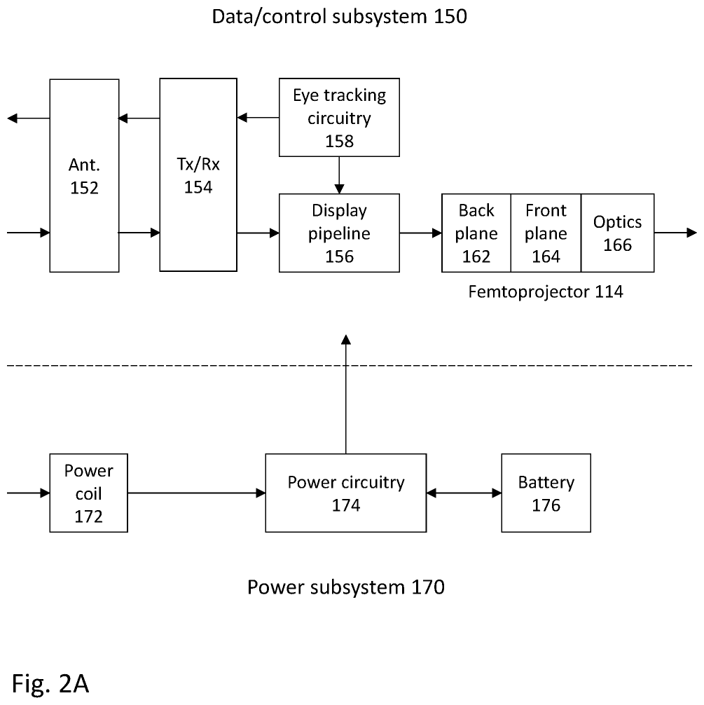

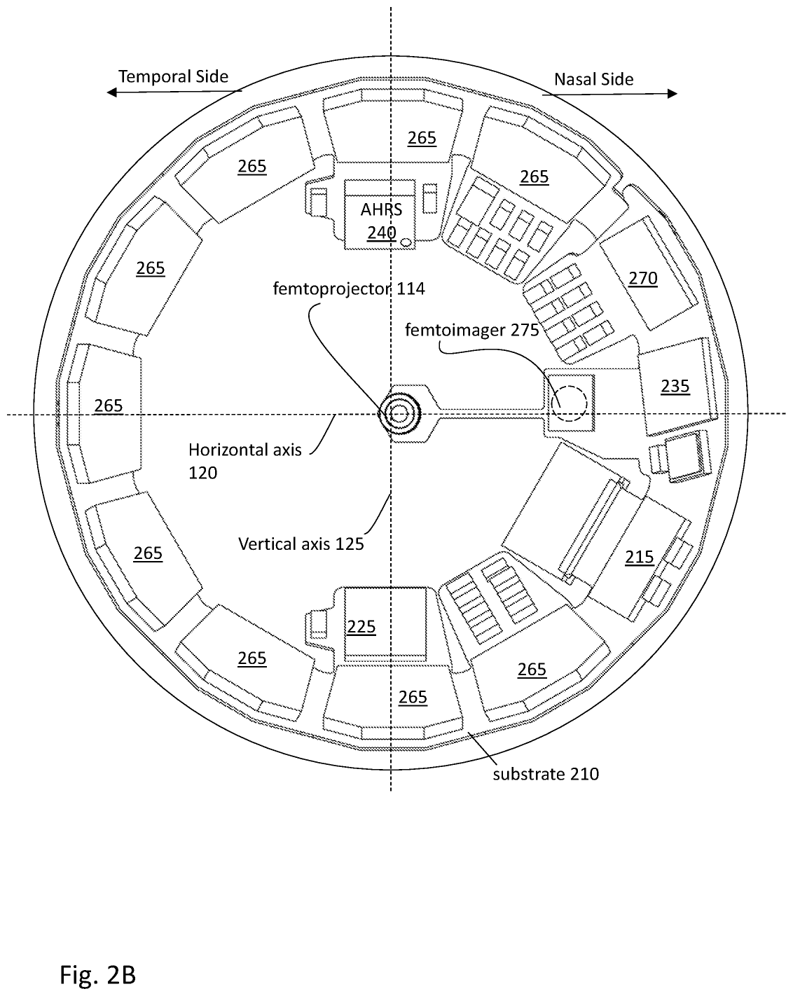

FIG. 2A is a functional block diagram of an eye-mounted display using a scleral contact lens, in accordance with some embodiments. The display can be divided into a data/control subsystem 150 and a power subsystem 170. In some embodiments, the receive path of the data/control subsystem 150 includes an antenna 152, receiver circuitry 154, a data pipeline 156, and a femtoprojector 114. Data from an external source (e.g., an external device such as an accessory device) is wirelessly transmitted to the display via the antenna 152. The receiver circuitry 154 performs the functions for receiving the data, for example demodulation, noise filtering, and amplification. It also converts the received signals to digital form. The pipeline 156 processes the digital signals for the femtoprojector 114. These functions may include decoding, and timing. The processing may also depend on other signals generated internally within the contact lens, for example eye tracking 158 or ambient light sensing. The femtoprojector 114 then projects the corresponding images onto the wearer's retina. In this example, the femtoprojector 114 includes a CMOS ASIC backplane 162, LED frontplane 164 and optics 166.

The data/control subsystem 150 may also include a back channel through transmitter circuitry 154 and antenna 152. For example, the contact lens may transmit eye tracking data, control data and/or data about the status of the contact lens.

In some embodiments, power is received wirelessly via a power coil 172. This is coupled to circuitry 174 that conditions and distributes the incoming power (e.g., converting from AC to DC if needed). The power subsystem 170 may also include energy storage devices, such as batteries 176 or capacitors (not shown), in addition to or instead of the power coil 172. For example, in some embodiments, the power coil 172 is used to charge the battery 176, which distributes power to the components of the data/control subsystem 150. In some embodiments, the contact lens may comprise the battery 176 but no power coil 172, or vice versa.

In addition to the components shown in FIG. 2A, the overall system may also include components that are outside the contact lens (i.e., off-lens). For example, head tracking and eye tracking functions may be performed partly or entirely off-lens (e.g., a sensor within the contact lens transmits raw sensor data to an external device, which analyzes the received data to calculate a head or eye orientation). The data pipeline may also be performed partially or entirely off-lens. Each of the arrows on the left-hand side of FIG. 2A also connects to an off-lens component. The power transmitter coil is off-lens, the source of image data and control data for the contact lens display is off-lens, and the receive side of the back channel is off-lens. For example, in some embodiments, the contact lens may receive image content to be displayed by the femtoprojector 114 from an external device associated with the user via the antenna 152. The external device may further communicate with a server (e.g., a remote server) to generate the image content.

FIG. 2B is a posterior view of an electronics assembly for use in an electronic contact lens, in accordance with some embodiments. The electronics assembly may be approximately dome-shaped in order to fit into the contact lens. The posterior view of FIG. 2B shows a view from inside the dome. The perimeter of the dome is close to the viewer and the center of the dome is away from the viewer. The surfaces shown in FIG. 2B face towards the user's eye when the user is wearing the contact lens.

In some embodiments, the electronics assembly has a flexible printed circuit board or substrate 210 on which the different components are mounted. Conductive traces on the circuit board provide electrical connections between the different components. This flexible substrate 210 may be formed as a flat piece and then bent into the three-dimensional dome shape to fit into the contact lens. In the example of FIG. 2B, the components include the femtoprojector 114. Other components include a display pipeline 235, receiver/transmitter circuitry 215, eye tracking/image stabilization circuitry 225, attitude and heading sensors and circuitry 240 (such as accelerometers, magnetometers and gyroscopes, also referred to as attitude and heading reference system, or AHRS), batteries 265 and power circuitry 270. The electronic contact lens may also include antennae and coils for wireless communication and power transfer. In some embodiments, the electronics assembly may also include a femtoimager 275. The femtoimager 275 faces outwards to capture images of the user's surrounding environment, so it is on the opposite side of the substrate 210 and is shown by hidden lines in FIG. 2B.

As shown in FIGS. 1C and 2B, the electronic components of an electronic contact lens occupy space within the lens, and may be arranged in a layout that distributes the components over different regions within the lens, in a way that maintains balance within the lens and reduces obscuration of the user's vision when the user is wearing the lens. For example, as shown in FIG. 2B, the electronic components of the payload, such as batteries 265, are placed around a periphery of the contact lens, creating a balanced distribution of components above and below the horizontal axis 120 of the content lens. This gives the contact lens a more even weight distribution. In addition, as shown in FIG. 2B, the area covered by the electronic components may be configured to cover a larger area near the nasal side of the lens, and a smaller area on the temporal side of the lens, to avoid obscuring the user's peripheral vision, e.g., by placing a greater number of components of the electronic payload on the nasal side of the contact lens in comparison to the temporal side.

In some embodiments, the substrate 210 may have multiple mounting locations to accommodate different combinations of electronic components, where each of the left and right electronic payloads includes a common first set of components (e.g., display pipeline 235, femtoprojector 114, receiver/transmitter circuitry 215, batteries 265 and power circuitry 270), and different second sets of components, e.g., eye tracking/image stabilization circuitry 225, attitude and heading sensors and circuitry 240. For example, in some embodiments, the left electronic payload may contain the eye tracking/image stabilization circuitry 225, but not the attitude and heading sensors and circuitry 240, and vice versa for the right electronic payload. In some embodiments, one or more of the mounting locations of the substrate 210 may be empty, allowing for identical substrates 210 to be used for both the left and right electronic payloads.

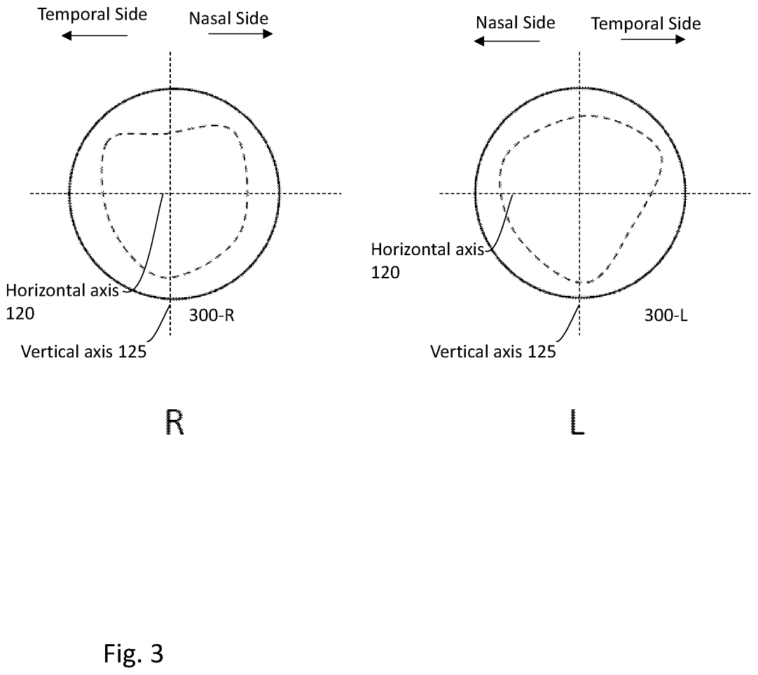

The electronic payloads of each contact lens of the pair of electronic contact lenses is mounted on or encapsulated within a respective lens component. In some embodiments, because each of the lens components is configured to touch the sclera of the user's eye when worn, the surface shape of each lens component may be customized based on the eyes of the user, e.g., to align with the contours of the particular user's eyes. FIG. 3 illustrates an overhead view of the lens components of a pair of contact lenses, in accordance with some embodiments. The pair of contact lenses includes a right lens 300-R and a left lens 300-LR. As illustrated in FIG. 3, the solid lines represent the outline of each contact lens 300-R or 300-L, while the dashed lines represent contours in the scleral landing region of each of the lens, e.g., an outline of the portions of the posterior surface of the lens that directly contact the user's sclera when worn. As the shape of a user's left and right sclera are different and are not necessarily symmetrical, the posterior surfaces of the left and right lens, being shaped based on the contours of an outer surface of a respective eye of the user, may not necessarily be symmetrical or be related by any type of symmetry. Thus, as discussed above, each of the right and left contact lenses 300-R and 300-L are configured to, when worn, rest upon a respective eye of the user with a fixed orientation relative to the user's eye, and the vertical and horizontal axes 125 and 120 of each contact lens correspond to fixed axes on the contact lens, regardless of the actual orientation of the contact lens at a given time. Similarly, although nasal and temporal may refer to sides of the lens when worn by the user, because of the known fixed orientation of each lens when worn, each lens will have a fixed nasal and temporal side, even when not worn by the user. However, as shown in FIG. 3, the nasal and temporal side of the right and left lenses 300-R and 300-L are on opposite sides of the respective lenses, due to the lenses being on different sides of the user's nose when worn.

The lens components of each of the left and right contact lenses may be made of a transparent plastic material, such as a rigid gas permeable (“RGP”) plastic, a poly(methyl methacrylate) (“PMMA”), or some combination thereof. In some embodiments, the lens components may contain different layers and/or structural features (not shown) to facilitate gas permeability of the contact lens, to ensure that the user's cornea is sufficiently oxygenated when the user is wearing the contact lenses.

As discussed above, electronic contact lens are, for many applications, worn in pairs. However, it can be impractical to design and manufacture two different layouts for the same or similar electronic payloads to be carried by the left and right lenses in a contact lens pair. For example, as discussed above, because most integrated circuits are only available in one handedness, designing left and right payload layouts that are mirror images of each other may be impractical due to the differences in routing needed to accommodate the components in the same relative positions within the layout. In addition, managing two different versions of the electronic payload (e.g., and left-eye and a right-eye version) introduces additional logistical costs and complexity during manufacture and assembly.

In some embodiments, the electronic payloads of the left and right contact lens for an electronic contact lens pair are manufactured as having a common layout. During assembly, the orientation of the payloads relative to a reference axis of their respective lens are offset relative to each other by a specified angle, referred to as the angle of rotation or rotational offset, corresponding to a rotation around a gaze axis of the respective lens. In some embodiments, where the angle of rotation is 180 degrees, the payloads of the left and right lenses are functionally symmetric to each other across the vertical axis of the lenses. For example, as illustrated in FIG. 2B, the payloads for each lens may be oriented to cover a larger area on the nasal side of the lens in comparison to the temporal side of the lens.

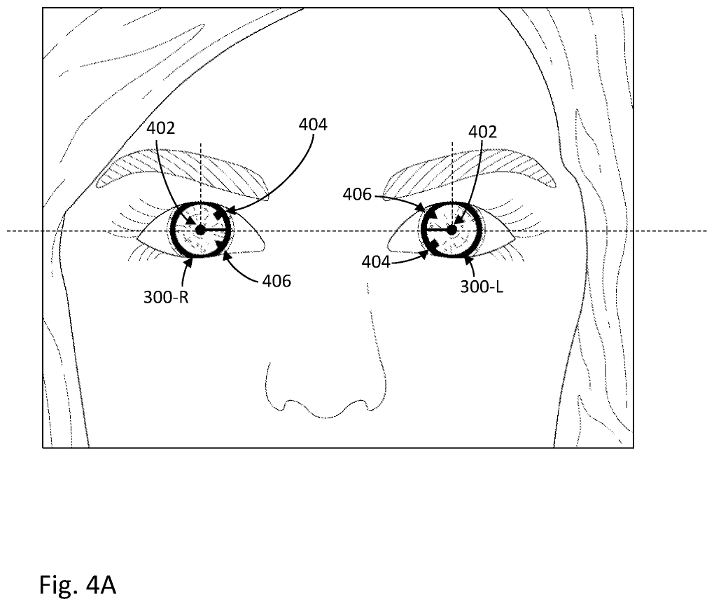

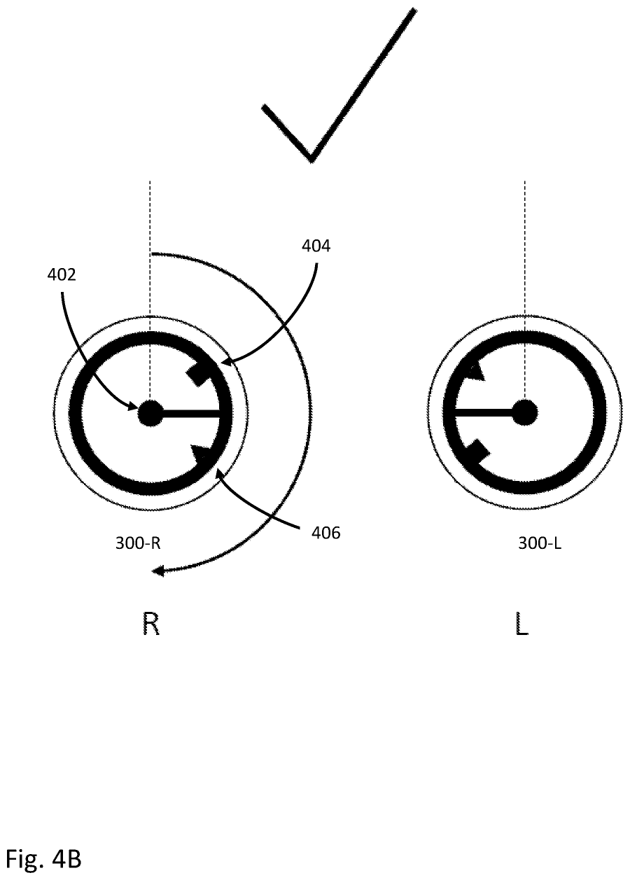

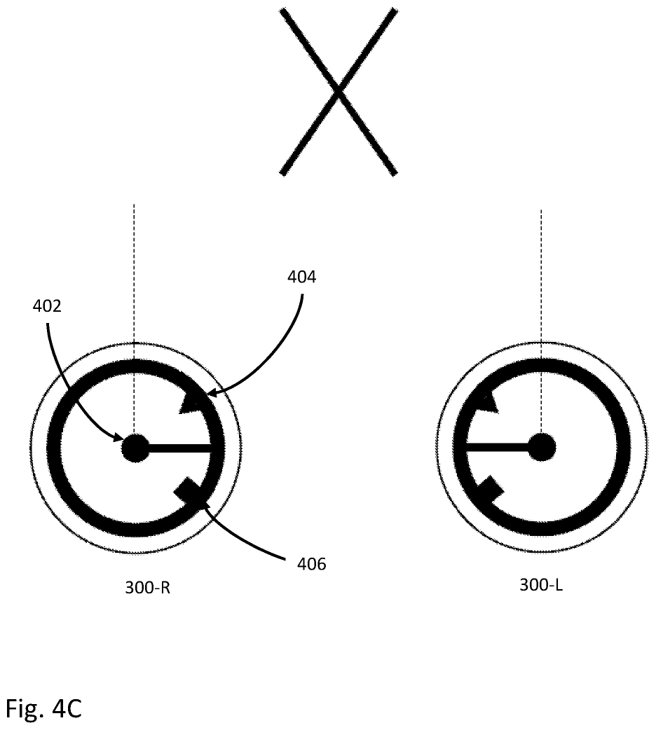

FIG. 4A illustrates a diagram showing a pair of electronic contact lens worn by a user, in accordance with some embodiments. As shown in FIG. 4A, the user wears a respective electronic contact lens in each eye, e.g., right contact lens 300-R in their right eye, and left contact lens 300-L in their left eye. Each contact lens includes a femtoprojector 402 positioned near a center of the contact lens, as well as additional first electronic components 404 and second electronic components 406 (represented in FIG. 4A as a square and a triangle, respectively). In some embodiments, the additional first and second electronic components 404 and 406 may correspond to different sets of electronic components, such as portions of the common first set of components discussed above. For example, referring back to FIG. 2B, the first electronic components 404 may include AHRS and power circuitry, while the second electronic components 406 includes receiver/transmitter circuitry and eye tracking/image stabilization circuitry.

FIG. 4B illustrates a closer view of the orientations of the left and right contact lenses 300-L and 300-R shown in FIG. 4A when worn by the user, in accordance with some embodiments. As shown in FIGS. 4A and 4B, the left contact lens 300-L and the right contact lens 300-R contain the same arrangement of electronic components within their respective payloads, where the layout of right contact lens 300-R has an orientation relative to the vertical axis of the right contact lens that is rotated by a specified angle (e.g., 180 degrees) about the gaze axis of the right contact lens, in comparison to the orientation of the layout of the left contact lens 300-L relative to the vertical axis of the left contact lens. Said another way, each of the left and right electronic payloads are oriented at different rotation angles relative to a respective reference axis (e.g., vertical axis) of their respective lens. For example, the left electronic payload may have an orientation rotated by a specified angle (e.g., 90 degrees) around the gaze axis from a first side the vertical axis of the left contact lens, while the right electronic payload may have an orientation rotated by the specified angle (e.g., 90 degrees) around the gaze axis from a second side the vertical axis of the right contact lens (such that the angle of rotation between the orientations of the left and right electronic payloads is twice that of the specified angle, e.g., 180 degrees). In some embodiments, a weight distribution of and area covered by the electronic components of the electronic payloads oriented at first rotation angle relative to the vertical axis is symmetrical across the vertical axis as when the payloads are oriented at a second, different rotation angle relative to the vertical axis.

Consequently, the first electronic components 404 and second electronic components 406 are positioned near the nasal side for both the left and right contact lenses 300-L and 300-R. However, while the first electronic components 404 and second electronic components 405 are positioned above and below the horizontal axis of the contact lens, respectively, in the right contact lens 300-R, the reverse is true, where the first electronic components 404 and the second electronic components 406 are positioned below and above the horizontal axis of the left contact lens, respectively. Additionally, due to the different orientation of each payload relative to the vertical axis of the respective lens, the orientation of electronic components on each lens of the pair of electronic contact lens is different. For example, where the angle of rotation is 180 degrees, the femtoprojector 402 on the left contact lens will be upside down relative to the femtoprojector on the right contact lens. In addition, in some embodiments, each of the electronic payloads may contain additional electronic components (not shown) of a same type distributed both above and below of the horizontal axis of the respective electronic contact lenses (e.g., batteries 265 illustrated in FIG. 2B).

Thus, as shown in FIGS. 4A and 4B, the positions and orientations of the first and second electronic components 404 and 406 relative to the user's eye when the contact lenses are worn by the user are different for each eye. This is in contrast to if the electronic payloads of the left and right contact lenses were mirror images of each other. FIG. 4C illustrates a diagram of the left and right contact lenses, where the payloads of the left and right contact lenses are mirror images, in accordance with some embodiments. Where the left and right payloads are mirrored, the relative positions of the first and second electronic components relative to the horizontal axes is the same for both the left and right contact lens. However, as explained above, this requires two different payload layout designs for the same set of components, compared to the design shown in FIGS. 4A and 4B, where the same payload layout is used for both the left and right contact lens. For example, as can be seen in FIG. 4C, rotating the electronic payload of the right contact lens 300-R by 180 degrees would not yield the same layout and orientation as that of the left contact lens 300-L, unlike that shown in FIG. 4B.

In some embodiments, because the left and right electronic payloads are oriented differently within their respective lenses (e.g., as shown in FIGS. 4A and 4B), the layout of the electronic payload is designed to be “functionally symmetric” about a reference axis of each contact lens based upon the angle of rotation, e.g., the horizontal axis where the angle of rotation is 180 degrees. For example, in the embodiment illustrated in FIGS. 4A and 4B, the weight distribution and area covered by the first set of components 404 is designed to be approximately equivalent to the weight distribution and area covered by the second set of components 406, so that the distribution of components of the electronic payload is balanced across the horizontal axis of the lens. Thus, even though the first and second components 404 and 406 are located at different positions relative the each eye of the user when the lenses are worn, the weight distribution and area covered by the electronic payload on each eye will be approximately symmetrical about the horizontal axis. In addition, the weight distribution and area covered of the right electronic payload will be approximately symmetrical with that of the left electronic payload across the vertical axis. In addition, the different orientations of the electronic payloads within each lens allows for matching levels of obscuration caused by the payload of each lens (e.g., less obscuration on the temporal side of each lens, and more obscuration on the nasal side).

In some embodiments, differences in position and orientation of electronic components are compensated for in software. For example, in some embodiments, a particular sensor component (e.g., an eye tracking/orientation sensor, a femtoimager, and/or the like) may be located above the horizontal axis on the left contact lens, while the same sensor on the right contact lens will be located below the horizontal axis. In such cases, a processor receiving data from each of the sensors on the left and right contact lenses may adjust the data based on the position and/or orientation of each sensor on its respective contact lens. Similarly, in some embodiments, the femtoprojector of the left contact lens may be in a first orientation when worn by the user, while the femtoprojector of the right contact lens may be in a second different orientation (e.g., based on the rotational offset relative to the femtoprojector of the left contact lens). To compensate for the different orientations of the femtoprojectors, image data for display by the femtoprojectors may be modified in software based on the orientation of each femtoprojector.

In some embodiments, one or more electronic components of the payload are positioned on a flexible portion of the payload (e.g., a flexible substrate), allowing for some degree of freedom of the alignment of the component. For example, in some embodiments, the orientation or tilt of the femtoprojector of the electronic payload with respect of the center axis of the contact lens may be adjusted within a certain angular range (e.g., ±5-10 degrees), allowing for the orientation of the femtoprojector to be customized for each eye of the user. In some embodiments, this tilt is adjustable in a direction orthogonal to the horizontal axis, in a direction based upon the rotational offset between the left and right contact lenses, or some combination thereof. For example, where the rotational offset between the left and right contact lenses is 180 degrees, the tilt of the femtoprojectors of each of the left and right lens may be adjustable along the vertical axis, so that both femtoprojectors may have similar alignment (e.g., 5 degrees below the horizontal axis), even after rotation of one of the electronic payloads by 180 degrees relative to the other. In other embodiments, the tilt of each femtoprojector may be adjusted along both the vertical axis and the horizontal axis.

This tilt adjustment allows for the aiming direction of the femtoprojector to be changed, to configure the optical alignment of the femtoprojector to align with the user's pupil and retina. For example, in some embodiments, the orientation of one or more components of the electronic payload, such as the femtoprojector, is adjusted to a desired alignment/position when the payload is mounted on or encapsulated within a lens component, wherein the mounting or encapsulation of the payload fixes the orientation of the one or more components to the desired position.

In addition, in some embodiments, certain components of each electronic payload may be customized or adjusted, based on whether the payload is to be part of a left contact lens or a right contact lens. For example, in some embodiments, the electronic payloads for left and right contact lenses may include the same layout of femtoimager electronics, but different optical systems attached to each femtoimager. For example, the optical system attached to the femtoimager of a left contact lens may be upside down relative to the optical system attached to the femtoimager of a right contact lens, so that when the pair of contact lenses is worn, the optical systems of both lenses are oriented in the same way relative to the user's eyes (whereas the femtoimagers of each lens will be oriented upside down relative to each other). In addition, in some embodiments, the electronic payloads for the left and right contact lenses may include different electronic components having similar size and layout (e.g., different types of sensors) placed in equivalent locations within the layout, allowing for the pair of contact lenses to include different types of components in each lens, without the need to design a new layout for each payload.

While the electronic payloads of the left and right contact lenses may exhibit matching layout when rotated by a specified angle relative to each other (e.g., relative to the vertical axis) as described above, the respective lens components of the left and right electronic contact lenses may not match when rotated by the specified angle relative to each other. In some embodiments, during assembly of a pair of electronic contact lenses such as those described above, electronic payloads for left and right electronic contact lens are initially placed on or encapsulated in respective uniform lens components, referring to lens components whose outer surface has not yet been shaped based on the contours of a user's eye. In some embodiments, the electronic payloads of the left and right contact lens may have identical layouts, allowing for the same type of manufactured electronic payload assembly to serve as either the left or right electronic payload for the pair of electronic contact lenses. In other embodiments, the electronic payloads of the left and right contact lenses may contain different types of electronic components arranged in an equivalent layout (e.g., where relative positions of the electronic components are equivalent, but the specific types of components and the routing between them may be different). In some embodiments, a property of one or more components of each electronic payload (e.g., the tilt of a femtoprojector or femtoimager, or an optical system attached to a femtoprojector or femtoimager) may be adjusted when placing the electronic payload on or encapsulating it within the respective lens component, based on whether the electronic payload is intended to be part of the left or right contact lens for a user. After the electronic payloads are placed on or encapsulated in respective uniform lens components, the surfaces of each lens component is shaped based on the contours of the user's left or right eye. In some embodiments, in order to maintain the rotational position of the lens, each lens component may include an alignment feature (e.g., corresponding to a nasal side of the lens), where the electronic payload is initially placed on or encapsulated within the lens component based on the alignment feature and whether the lens is to be a left or right contact lens (e.g., such that the electronic payload is positioned in a first orientation relative to the alignment feature if the lens is to be a left contact lens, or a second orientation relative to the alignment feature for right contact lens, where the second orientation is offset relative from the first orientation by a predetermined rotational offset). Subsequently, each of the lens components may be shaped based on the surfaces of the user's eyes relative to the alignment feature, after which left and right contact lens are rotated relative to each other by the specified angle.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A pair of electronic contact lenses, comprising:
a left electronic contact lens to be worn on a left eye of a user, and a right electronic contact lens to be worn on a right eye of the user;
wherein each of the left and right electronic contact lenses has a respective vertical axis oriented orthogonally to a respective gaze axis of the lens; and
wherein each of the left and right electronic contact lenses contains a respective electronic payload comprising one or more electronic components, wherein the electronic payloads for the left and right electronic contact lenses have an equivalent layout of electrical components but are oriented at different rotation angles relative to the vertical axis of the respective contact lenses.

2. The pair of electronic contact lenses of claim 1, where the layout of the electronic payload of the left contact lens is not a mirror image of the layout of the electronic payload of the right contact lens.

3. The pair of electronic contact lenses of claim 1, wherein the rotation angles correspond to a rotation around a gaze axis of the left or right electronic contact lens orthogonal to the vertical axis.

4. The pair of electronic contact lenses of claim 1, wherein the rotation angles of the electronic payloads of the left and right electronic contact lenses are 180 degrees apart.

5. The pair of electronic contact lenses of claim 1, wherein the rotation angles of the electronic payloads of the left and right electronic contact lenses are selected based upon an inclination angle of a palpebral fissure of the user.

6. The pair of electronic contact lenses of claim 1, wherein the electronic payload of the left contact lens is oriented at a specified rotation angle from a first side of the vertical axis, and the electronic payload of the right contact lens is oriented at the specified rotation angle from a second side of the vertical axis opposite the first side.

7. The pair of electronic contact lenses of claim 1, wherein a weight distribution of the plurality of electronic components of each of the respective electronic payloads is balanced across a horizontal axis of the respective electronic contact lenses.

8. The pair of electronic contact lenses of claim 1, wherein an area covered by the plurality of electronic components of each of the respective electronic payloads is balanced across a horizontal axis of the respective electronic contact lenses.

9. The pair of electronic contact lenses of claim 1, wherein a weight distribution of the plurality of electronic components of each of the respective electronic payloads oriented at first rotation angle relative to the vertical axis is symmetrical across the vertical axis as when oriented at a second, different rotation angle relative to the vertical axis.

10. The pair of electronic contact lenses of claim 1, wherein the layout of the plurality of electronic components of each of the respective electronic payloads comprises a plurality of a first type of component distributed on both sides of a horizontal axis of the respective electronic contact lenses.

11. The pair of electronic contact lenses of claim 1, wherein the electronic payload of each of the left and right lenses covers a larger area towards a center the respective lens on a nasal side of the lens in comparison to a temporal side of the lens.

12. The pair of electronic contact lenses of claim 1, wherein the plurality of electronic components of the electronic payloads of the left and right electronic contact lenses includes an electronic component where a tilt corresponding to an angle of the electronic component relative to a gaze axis of the left or right electronic contact lens is adjustable.

13. The pair of electronic contact lenses of claim 1, wherein the plurality of electronic components of the electronic payloads of the left and right contact lenses includes a femtoprojector.

14. The pair of electronic contact lenses of claim 1, wherein each of the left and right electronic contact lenses further comprises a respective lens component, wherein the electronic payload of the each of left and right electronic contact lenses is mounted on or encapsulated within the respective lens component.

15. The pair of electronic contact lenses of claim 14, wherein the respective lens components of the left and right electronic contact lenses each have an posterior surface that contacts the respective left and right eye of the user when the pair of electronic contact lenses is worn by the user.

16. The pair of electronic contact lenses of claim 15, where the posterior surfaces of the respective lens components are each shaped based on an outer surface of a respective eye of the user.

17. The pair of electronic contact lenses of claim 14, wherein the respective lens components of the left and right electronic contact lenses do not match when rotated by a specified angle relative to the vertical axis.

18. The pair of electronic contact lenses of claim 14, wherein the respective lens components of the left and right electronic contact lenses provide optical refractive correction.

19. A pair of electronic contact lenses, comprising:
a left electronic contact lens to be worn on a left eye of a user in a first orientation and a right electronic contact lens to be worn on a right eye of the user in a second orientation, wherein the left electronic contact lens has a first reference axis that is oriented in a first direction when the left electronic contact lens is in the first orientation, and the right electronic contact lens has a second reference axis that is oriented in the first direction when the right electronic contact lens is in the second orientation;
wherein each of the left and right electronic contact lenses contains a respective electronic payload comprising a plurality of electronic components, wherein the electronic payloads for the left and right electronic contact lenses have a same layout of the plurality of electrical components within the payload but are oriented at different rotation angles relative to the respective first and second reference axes.

20. A pair of electronic contact lenses, comprising:
a left electronic contact lens to be worn on a left eye of a user, having a first reference axis configured to be oriented in a first direction when the left electronic contact lens is worn by the user;
a right electronic contact lens to be worn on a right eye of the user, having a second reference axis configured to be oriented in the first direction when the right electronic contact lens is worn by the user;
wherein each of the left and right electronic contact lenses contains a respective electronic payload comprising a plurality of electronic components, wherein the electronic payloads for the left and right electronic contact lenses have a same layout of the plurality of electrical components within the payload but are oriented at different rotation angles relative to the respective first and second reference axes.
